(19) United States
(12) Patent Application Publication
(10) Pub. No.: US 2026/0253347 A1
(43) Pub. Date: Aug. 27, 2026

(54) ELECTRONIC DEVICE THAT GENERATES AND TRANSMITS DATA OF VIRTUAL OBJECT, AND DISPLAY DEVICE THAT RECEIVES DATA OF VIRTUAL OBJECT AND DISPLAYS VIDEO OF VIRTUAL OBJECT

(71) Applicant: CANON KABUSHIKI KAISHA, Tokyo (JP)

(72) Inventor: SAYAKA HARADA, Saitama (JP)

(21) Appl. No.: 19/451,246

(22) Filed: Jan. 16, 2026

(30) Foreign Application Priority Data
Feb. 26, 2025 (JP) 2025-028587

(51) Int. Cl. G06T 19/00; G06F 3/14; G06T 3/40

(52) U.S. Cl. CPC G06T 19/006; G06F 3/14; G06T 3/40; G06T 2210/62

(57) ABSTRACT

An electronic device according to the present disclosure includes one or more processors and/or circuitry configured to execute first acquisition processing of acquiring information of a position and an orientation of a display device, generation processing of generating one piece of image data including data of a virtual object image representing a virtual object, data of transparency of the virtual object image, and data of a depth of the virtual object, on a basis of the information acquired by the first acquisition processing, and transmission processing of transmitting the one piece of image data generated by the generation processing to outside.

### BACKGROUND

### Field of the Technology

The present disclosure relates to an electronic device that generates and transmits data of a virtual object, and a display device that receives the data of the virtual object and displays a video of the virtual object.

### Description of the Related Art

A mixed reality (MR) technology and an augmented reality (AR) technology are known as a technology for seamlessly fusing the real world and the virtual world in real time. These are expected to be applied to various fields such as assembly support for displaying a work procedure and a state of wiring in a superimposing manner at the time of assembly work, and surgery support for displaying a state in a body on a body surface of a patient in a superimposing manner. In addition, a virtual reality (VR) technology is known as a technology for providing a virtual environment and experience different from reality using computer technology. By using a head mounted display (HMD) or a controller to experience a virtual reality space, the user can feel as if the user is actually at the location or situation.

A video see-through type device may be used to make the user feel that a virtual object exists. A video see-through type device images a real space with a camera, and displays a composite image in which an image of a virtual object is superimposed on an image (background image) of the real space on a display unit such as a display in real time. As such a device, a portable information terminal (for example, a tablet terminal or the like) having a camera on a back surface, a video see-through HMD equipped with a camera, or the like is used.

In a video see-through HMD, there is a case where an image acquired from a mounted camera and information regarding the position and the orientation of the camera are transmitted to an information processing apparatus. In this case, the information processing apparatus performs composition processing of superimposing the image of the virtual object on the background image, and transmits the composite image to the HMD. The HMD displays the received composite image to the user. Usually, since the data amount of the composite image is large, the communication amount between the information processing apparatus and the HMD increases, and a delay may occur in the display of the composite image.

Japanese Patent Laid-Open No. 2019-062397 discloses a technique for reducing a communication amount by performing frame thinning processing of a composite image.

However, the technique disclosed in Japanese Patent Laid-Open No. 2019-062397 reduces the frame rate. Therefore, a configuration in which data of a virtual object before composition is transmitted to the HMD and composition processing is performed by the HMD is also conceivable. According to this configuration, since the data amount of the virtual object is smaller than the data amount of the composite image, the communication amount between the information processing apparatus and the HMD can be reduced. However, in order to correctly represent occlusion, data of a virtual object image, transparency information of the virtual object image, and depth information of the virtual object are required as data of the virtual object, and in order to adopt the above-described configuration, it is necessary to use a special communication standard (communication scheme).

### SUMMARY

The present disclosure provides a technique capable of transmitting and receiving data of a virtual object according to a general communication standard.

An electronic device according to the present disclosure includes one or more processors and/or circuitry configured to execute first acquisition processing of acquiring information of a position and an orientation of a display device, generation processing of generating one piece of image data including data of a virtual object image representing a virtual object, data of transparency of the virtual object image, and data of a depth of the virtual object, on a basis of the information acquired by the first acquisition processing, and transmission processing of transmitting the one piece of image data generated by the generation processing to outside.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of a system according to a first embodiment.

FIG. 2 is a block diagram of an information processing apparatus according to the first embodiment.

FIG. 3 is a block diagram of an HMD according to the first embodiment.

FIG. 4 is a flowchart of the information processing apparatus according to the first embodiment.

FIG. 5 is a flowchart of the HMD according to the first embodiment.

FIGS. 6A to 6F are schematic diagrams illustrating data of a virtual object according to the first embodiment.

FIG. 7 is a flowchart of an information processing apparatus according to a second embodiment.

FIG. 8 is a schematic diagram illustrating data of a virtual object according to the second embodiment.

FIG. 9 is a sequence chart of a system according to a third embodiment.

FIG. 10 is a schematic diagram of a screen according to the third embodiment.

FIG. 11 is a sequence chart of a system according to a fourth embodiment.

FIG. 12 is a schematic diagram of a screen according to the fourth embodiment.

### DESCRIPTION OF THE EMBODIMENTS

### First Embodiment

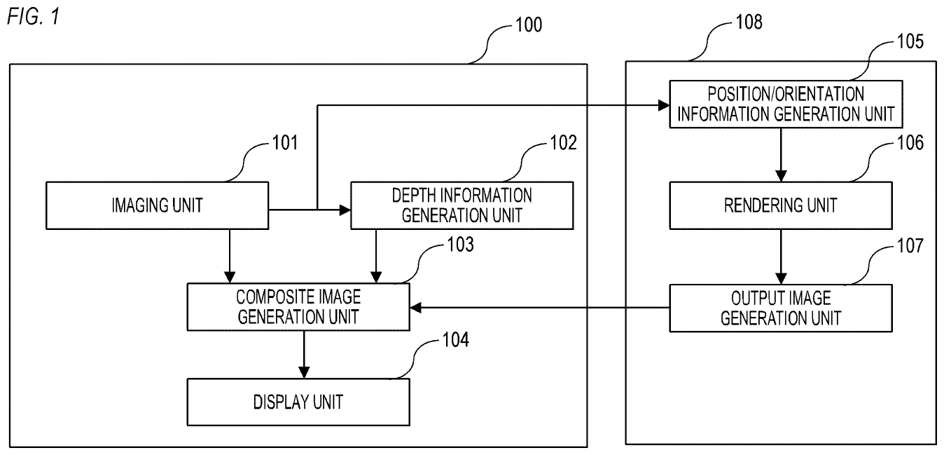

FIG. 1 is a block diagram illustrating a configuration of a mixed reality system according to a first embodiment. An HMD 100 (display device) includes an imaging unit 101, a depth information generation unit 102, a composite image generation unit 103, and a display unit 104. An information processing apparatus 108 (electronic device) includes a position/orientation information generation unit 105, a rendering unit 106, and an output image generation unit 107.

The HMD 100 is an example of a video see-through type display device. It is sufficient that the video see-through type display device includes the imaging unit 101, the depth information generation unit 102, the composite image generation unit 103, and the display unit 104. The video see-through type display device may be, for example, a portable information terminal such as a tablet and a smartphone, a display device such as a handheld display (HHD), or the like. The HMD 100 transmits a background image (to be described later) to the position/orientation information generation unit 105 of the information processing apparatus 108. In the first embodiment, the HMD 100 and the information processing apparatus 108 are connected by wire, but the HMD 100 and the information processing apparatus 108 may be wirelessly connected.

A user wears the HMD 100 on the head for use. The HMD 100 has an information processing function, but an HMD specialized in a photographing function and a display function and an information processing apparatus specialized in an information processing function may be used instead of the HMD 100.

The imaging unit 101 includes a camera (imaging device) that continuously captures images of the real space. In the first embodiment, the image of the real space (real space image) captured by the camera is used as the background image. However, the background image is not limited to a real-time real space image, and may be, for example, a moving image or a still image that is a real space image stored in advance in a storage medium. The background image may be a moving image, a still image, or the like representing the virtual space. The background image captured by the imaging unit 101 is input to the depth information generation unit 102 and the position/orientation information generation unit 105 of the information processing apparatus 108. For example, the imaging unit 101 includes a USB interface board, and outputs a background image to the outside from the USB interface board. In the first embodiment, the camera included in the imaging unit 101 is a stereo camera including two cameras corresponding to the left and right eyes of the user. However, the camera included in the imaging unit 101 is not particularly limited, and may be, for example, a monocular camera.

The depth information generation unit 102 acquires depth information from the image captured by the imaging unit 101. For example, depth information of a hand of the user is acquired, or depth information of an object held in the hand is acquired. The depth information is used to correctly represent occlusion when generating a composite image (described later). As a method of use thereof, various known methods can be used. A method described in Japanese Patent Laid-Open No. 2013-134706 may be used to detect a hand. In the method described in Japanese Patent Laid-Open No. 2013-134706, it is necessary to register color information in advance. Therefore, the color information may be registered in advance in the HMD 100 or a storage medium provided in the information processing apparatus 108, and the depth information generation unit 102 may read the color information. Alternatively, depth information may be acquired using a stereo camera. The method is not limited to these methods, and the method is not limited as long as the depth information can be acquired.

The composite image generation unit 103 combines (superimposes) a virtual object image (image representing a virtual object) received from the information processing apparatus 108 with the background image captured by the imaging unit 101 to generate a composite image (composite image data). In the composite image, pixels other than those in the region of the virtual object are pixels of the background image (real space image).

The display unit 104 is a display element provided in the HMD 100, and displays a video based on the composite image generated by the composite image generation unit 103. An EL (Electro Luminescence) panel, an LCD, or the like can be applied as the display element used for the display unit 104, but the display element is not limited thereto. The display unit 104 may have any form as long as it can display the composite image.

The position/orientation information generation unit 105 generates information (position/orientation information) on the position and the orientation of the camera (imaging device) included in the imaging unit 101. The position/orientation information of the imaging device may be generated on the basis of the background image or may be generated on the basis of the optical sensor. The position/orientation information may be interpreted as information on the position and the orientation of the HMD 100. In the case of using the optical sensor, it is necessary to obtain in advance the relative position and the orientation of the HMD 100 (imaging device) with respect to the optical sensor. In the first embodiment, the position/orientation information is estimated (acquired) from the background image. The position/orientation information generation unit 105 detects a feature from a background image repeatedly captured by the imaging unit 101. In the feature detection, for example, a feature point having a luminance gradient is detected. Here, the position/orientation information generation unit 105 detects a predetermined number or less of feature points, or selects and uses a predetermined number or less of feature points from the detected feature points. Details of the feature detection will be described later.

The rendering unit 106 renders a virtual object to be superimposed on the background image captured by the imaging unit 101.

The output image generation unit 107 generates one piece of image data (output image) including data of a virtual object image representing a virtual object, data of transparency of the virtual object image, and data of a depth of the virtual object, on the basis of a result of rendering by the rendering unit 106. The transparency data and the depth data are used to generate a composite image (described later). The transparency data is used to correctly represent light transmission and the like, and the depth data is used to correctly represent occlusion. As a method of using the data, various known methods can be used.

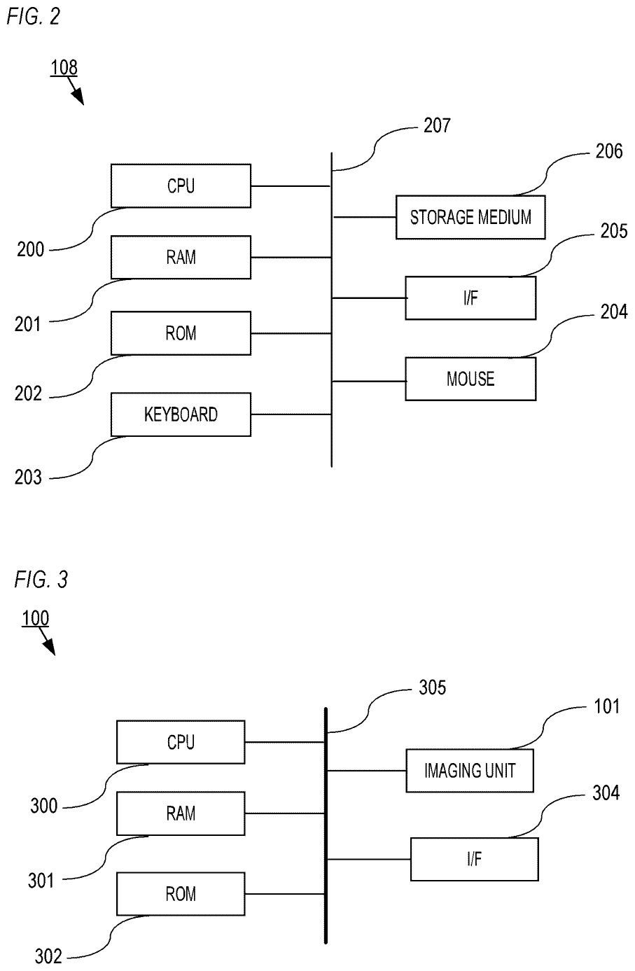

FIG. 2 is a block diagram illustrating a hardware configuration of the information processing apparatus 108. A CPU 200 integrally controls respective components of the information processing apparatus 108 connected via a bus 207. The CPU 200 reads and executes a program stored in a ROM 202 (read-only memory), thereby implementing the functions of the position/orientation information generation unit 105, the rendering unit 106, and the output image generation unit 107. The ROM 202 stores therein an operating system (OS), programs according to the first embodiment, device drivers, and the like. The programs and the like stored in the ROM 202 are temporarily stored in a RAM 201 (random access memory) and executed by the CPU 200. The keyboard 203 and the mouse 204 connected as the input I/F receive a user's operation on the information processing apparatus 108. An I/F 205 receives an input signal from an external device (such as a display device) in a format that can be processed by the information processing apparatus 108, and transmits an output signal to the external device in a format that can be processed by the device. For example, the I/F 205 receives image data and the like used for processing by the information processing apparatus 108 from the HMD 100 in a format that can be processed by the information processing apparatus 108. Furthermore, the I/F 205 transmits the image data to be displayed on the HMD 100 to the HMD 100 in a format that can be processed by the HMD 100. In the first embodiment, the DisplayPort standard is used for communication by the I/F 205, but the communication standard to be used is not limited thereto. For example, the HDMI (registered trademark) standard may be used.

FIG. 3 is a block diagram illustrating a hardware configuration of the HMD 100. A CPU 300 integrally controls respective components of the HMD 100 connected via a bus 305. The CPU 300 implements the functions of the depth information generation unit 102 and the composite image generation unit 103 by reading and executing a program stored in the ROM 302 (read-only memory). The ROM 302 stores therein an operating system (OS), processing programs according to the first embodiment, device drivers, and the like. The programs and the like stored in the ROM 302 are temporarily stored in a RAM 301 (random access memory) and executed by the CPU 300. An I/F 304 receives an input signal from an external device in a format that can be processed by the HMD 100, and transmits an output signal to the external device in a format that can be processed by the device. For example, the I/F 304 receives image data to be displayed on the HMD 100 from the information processing apparatus 108 in a format that can be processed by the HMD 100. Furthermore, the I/F 304 transmits image data and the like used for processing by the information processing apparatus 108 to the information processing apparatus 108 in a format that can be processed by the information processing apparatus 108. In the first embodiment, the DisplayPort standard is used for communication by the I/F 304, but the communication standard to be used is not limited thereto.

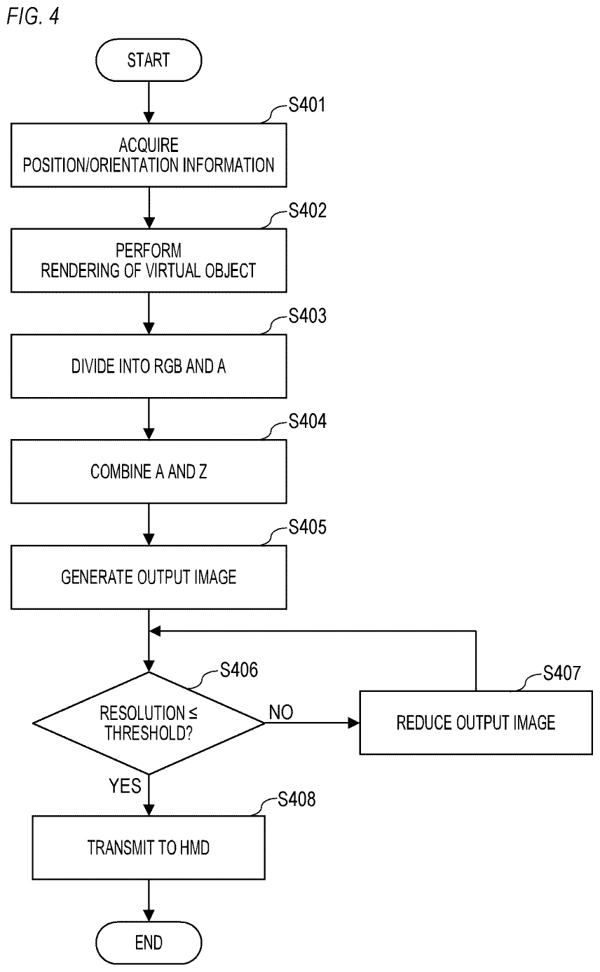

FIG. 4 is a flowchart of the information processing apparatus 108. Each processing shown in FIG. 4 is realized by the CPU 200 loading a program stored in the ROM 202 in the RAM 201 and executing the program. For example, the operation of FIG. 4 may be started when the user performs a predetermined operation such as a startup operation of an application for experiencing a mixed reality (MR) space using the HMD 100.

In S401, the CPU 200 (position/orientation information generation unit 105) acquires (estimates) position/orientation information of the HMD 100 (imaging device) using the background image. In the first embodiment, as the position/orientation information, a set of six parameters including three parameters representing the position and three parameters representing the orientation (posture) is acquired.

First, the position/orientation information generation unit 105 receives a background image captured by the imaging unit 101 from the HMD 100. The position/orientation information generation unit 105 performs feature detection on the received background image. Feature detection means detecting coordinates of a feature point in an image. Here, processing of detecting a feature point from an image will be described. For example, a point at which a luminance gradient is equal to or greater than a threshold between adjacent pixels is defined as a feature point. The luminance gradient is an amount of change in the density of adjacent pixels on the image. The detection of the luminance gradient is performed using a known edge detection operator such as a Sobel operator or a Prewitt operator. For each pixel, the edge detection operator is applied for the horizontal direction and the vertical direction of the image. Then, the edge intensity (luminance gradient) is calculated based on the output value. For a certain pixel, when the output value in the horizontal direction of the edge detection operator is fₓ and the output value in the vertical direction is f_{y}, the edge intensity I in the pixel is calculated using Expression (1).

$$\begin{matrix}[ Math . 1 ] & \\ I = \sqrt{( {f}_{x}^{2} + {f}_{y}^{2} )} & ( 1 )\end{matrix}$$

Then, the position/orientation information generation unit 105 estimates the position and the orientation of the HMD 100 on the basis of the detected feature points, and generates position/orientation information. Any existing method may be used as the method of estimating the position and the orientation. In the first embodiment, the position and the orientation at the timing of imaging are estimated using prediction such as an extended Kalman filter (EKF). The position/orientation information generation unit 105 obtains the preliminary internal state of the EKF at the timing t by using the difference Δt from the timing t−1 at which the previous image is captured to the timing t at which the current image is captured and the posterior internal state of the EKF at the timing t−1. Note that the method is not particularly limited as long as the position and the orientation at the imaging timing can be estimated.

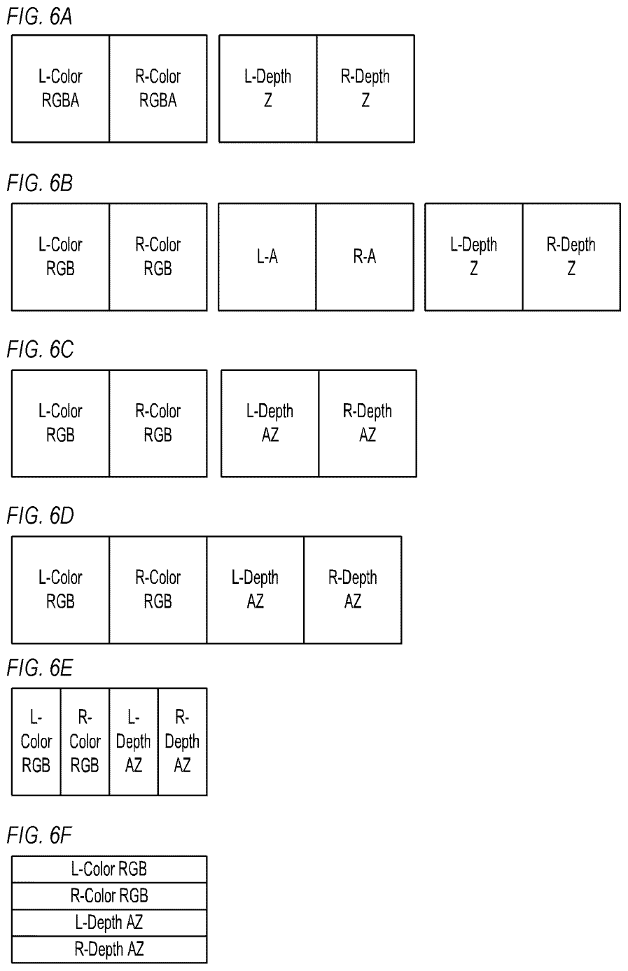

In S402, the CPU 200 (rendering unit 106) renders a virtual object. In order to determine the position and the orientation of the virtual object, the rendering unit 106 uses the position/orientation information estimated in S401. The 3D engine used by the rendering unit 106 for rendering the virtual object is not particularly limited. The rendering unit 106 generates RGBA data including color information and transparency information and Z data including depth information as a result of rendering. RGBA is a color model obtained by adding alpha (transparency) to the three primary colors of red, green, and blue. By specifying the intensity and the transparency of each color, it is possible to express a wide range of colors including transparency. Hereinafter, color information (virtual object image data) is referred to as RGB data, transparency information (transparency data) is referred to as A data, and depth information (depth data) is referred to as Z data. However, the color model of the color information is not limited to RGB, and may be another color model such as BGR or YCbCr. FIG. 6A is a schematic diagram illustrating an example of RGBA data and Z data. Since the HMD 100 of the first embodiment includes a right eye camera and a left eye camera, two pieces of data namely RGBA data for the right eye (R) and RGBA data for the left eye (L) are generated as the RGBA data. Similarly, two pieces of data, that is, Z data for the right eye (R) and Z data for the left eye (L), are generated as the Z data.

In S403, the CPU 200 (output image generation unit 107) divides the RGBA data generated in S402 into RGB data and A data. FIG. 6B is a schematic diagram illustrating an example of RGB data, A data, and Z data.

In S404, the CPU 200 (output image generation unit 107) combines the A data obtained in S403 and the Z data obtained in S402 to generate AZ data representing the transparency and the depth. The RGB data and the AZ data are obtained by the processing of S403 and S404. FIG. 6C is a schematic diagram illustrating an example of the RGB data and the AZ data.

In S405, the CPU 200 (output image generation unit 107) generates an output image including the RGB data, the A data, and the Z data. Here, the output image is generated by arranging the RGB data obtained in S403 and the AZ data obtained in S404. FIG. 6D is a schematic diagram illustrating an example of an output image in which the RGB data and the AZ data are arranged. The resolution (image size) of the output image generated in S405 may be arbitrarily selected by the user, or may be a fixed resolution predetermined by the manufacturer.

In S406, the CPU 200 (output image generation unit 107) determines whether or not the resolution (image size) of the output image generated in S405 is the resolution transmittable by the I/F 205. This determination may be interpreted as determination of whether or not the resolution of the output image is equal to or less than a threshold. In the first embodiment, the DisplayPort standard is used for communication by the I/F 205. Depending on the resolution of the image, transmission may not be possible in the DisplayPort standard. When it is determined that the resolution (image size) of the output image is the resolution that can be transmitted by the I/F 205 (the resolution that can be transmitted by the DisplayPort standard) (when the resolution of the output image is equal to or less than the threshold), the CPU 200 advances the processing to S408. Otherwise, the CPU 200 advances the processing to S407.

In S407, the CPU 200 (output image generation unit 107) performs image size reduction processing on the output image (RGB data, AZ data, or both). The output image generation unit 107 reduces the resolution of the output image to a resolution that can be transmitted by the I/F 205 (a resolution equal to or less than the threshold described above). A method of the reduction processing is not particularly limited, and for example, the reduction processing is performed using the graphics API. FIG. 6E is a schematic diagram illustrating an example of a reduced output image. In FIG. 6E, the horizontal size (size in the horizontal direction) of the output image of FIG. 6D is reduced (compressed) to half thereof.

In S408, the CPU 200 (output image generation unit 107) transmits the output image from the I/F 205 to the HMD 100. When the processing of S407 is performed, the reduced output image is transmitted.

Note that, in a case where the DisplayPort standard is used, the resolution defined by the DisplayPort standard may be used as the threshold of S406. Since the upper limit resolution of the DisplayPort1.0 standard is 3840×2160, the resolution of 3840×2160 or less may be used as the threshold of S406, and the resolution of the output image may be reduced to the resolution of 3840×2160 or less in S407. By doing so, transmission to the HMD 100 becomes possible even when any generation of the DisplayPort standard is used.

Although the example in which the RGB data and the AZ data are arranged in the horizontal direction has been described, the arrangement of the RGB data and the AZ data is not particularly limited. FIG. 6F is a schematic diagram illustrating an example of an output image in which the RGB data and the AZ data are arranged in the vertical direction.

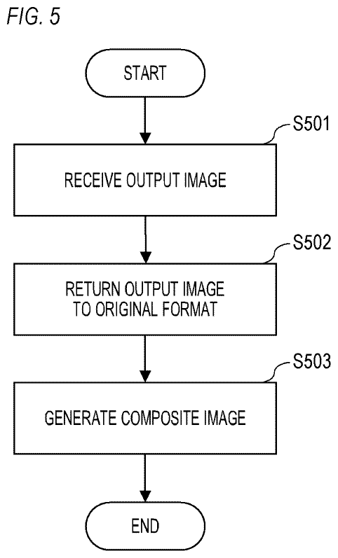

FIG. 5 is a flowchart of the HMD 100. Each processing illustrated in FIG. 5 is realized by the CPU 300 developing a program stored in the ROM 302 in the RAM 301 and executing the program.

In S501, the CPU 300 (composite image generation unit 103) receives the output image generated by the output image generation unit 107 from the information processing apparatus 108 via the I/F 304.

In S502, the CPU 300 (composite image generation unit 103) performs processing of returning the output image received from the information processing apparatus 108 to the original state (the state immediately after the rendering). The composite image generation unit 103 divides the output image into the RGBA data and the Z data. In a case where the reduced output image is received, the composite image generation unit 103 performs enlargement processing on the output image and divides the enlarged output image into the RGBA data and the Z data. A method of the enlargement processing is not particularly limited, and for example, pixel data interpolation processing using a shader is performed as the enlargement processing. The processing of S502 is, for example, reverse processing to the processing of S403 to S407 in FIG. 4.

In S503, the CPU 300 (composite image generation unit 103) generates a composite image by using the RGBA data and the Z data generated in S502, the background image captured by the imaging unit 101, and the depth information generated by the depth information generation unit 102. The generated composite image is displayed on the display unit 104. As a result, the composite image in which the virtual object image is combined with (superimposed on) the background image can be presented to the user, and the user can experience the MR space.

As described above, in the first embodiment, data of a virtual object can be transmitted and received by a general (general-purpose) communication standard. Therefore, a highly versatile device (such as an HMD or an information processing apparatus) can be used for the system, and the system can be realized at low cost. In addition, a system in which a processing load is distributed can be realized. Although the example in which the present disclosure is applied to the mixed reality system has been described, the present disclosure is also applicable to an augmented reality system, a virtual reality system, and the like.

### Second Embodiment

In the first embodiment, AZ data obtained by combining A data and Z data is generated, and RGB data and AZ data are arranged. However, in the second embodiment, RGB data, A data, and Z data are arranged without combining A data and Z data. In the description of the second embodiment, the same description as that of the first embodiment will be omitted.

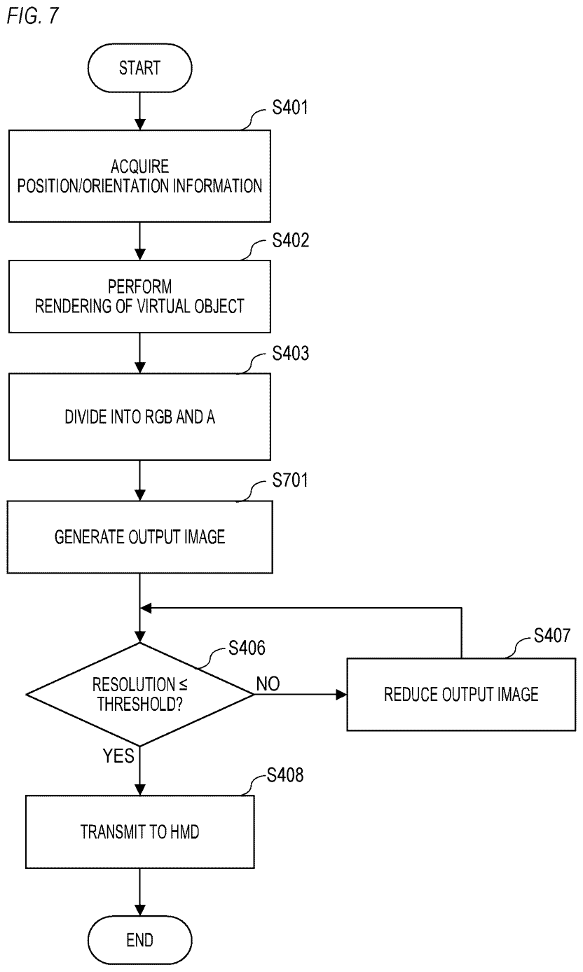

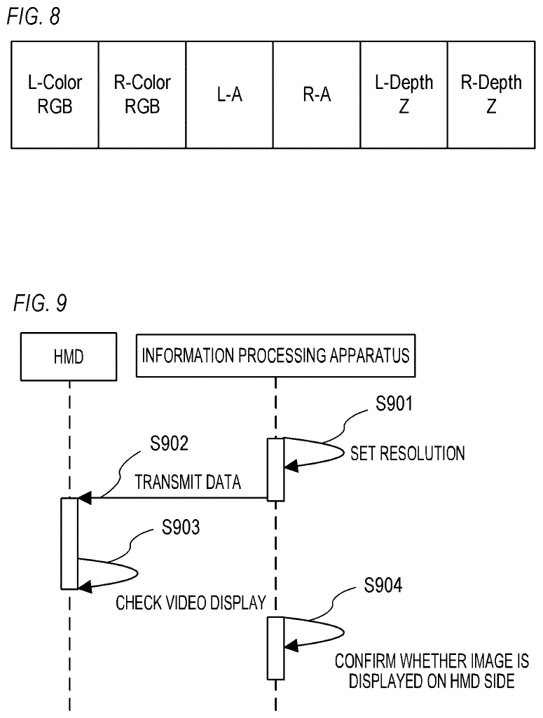

FIG. 7 is a flowchart of the information processing apparatus 108 according to the second embodiment. In FIG. 7, the processing of S404 in FIG. 4 is omitted, and the processing of S701 is performed instead of the processing of S405. In S701, the CPU 200 (output image generation unit 107) generates an output image including the RGB data, the A data, and the Z data. Here, the output image is generated by arranging the RGB data, the A data, and the Z data obtained by the processing of S402 and S403. FIG. 8 is a schematic diagram illustrating an example of an output image in which the RGB data, the A data, and the Z data are arranged. Although FIG. 8 illustrates an example in which the RGB data, the A data, and the Z data are arranged in the horizontal direction, the arrangement of the RGB data, the A data, and the Z data is not particularly limited.

As described above, in the second embodiment, data of a virtual object can be transmitted and received by a general (general-purpose) communication standard, similarly to the first embodiment.

### Third Embodiment

In the first embodiment, an output image having a set resolution (for example, a resolution arbitrarily selected by the user) is generated. However, the HMD 100 may not be able to receive or process the output image with the set resolution (the HMD 100 may not be able to display a video (composite image) based on the output image). In the third embodiment, the user is prompted to change the resolution of the output image so that the HMD 100 can display a video (composite image) based on the output image.

FIG. 9 is a sequence chart of the HMD 100 and the information processing apparatus 108 according to the third embodiment.

In S901, the CPU 200 (output image generation unit 107) performs setting of the resolution of the output image according to the user's operation. The resolution is not particularly limited. For example, a pull-down menu, an input box for directly inputting a numerical value of resolution, or the like may be displayed on a display connected to the information processing apparatus 108. In this case, the user can specify (set) the resolution using the keyboard 203 and the mouse 204. The setting of the resolution of the output image may be interpreted as the setting of the resolution of the virtual object.

In S902, the CPU 200 (rendering unit 106) renders a virtual object for test. The virtual image for test is used to allow the user to confirm whether or not the virtual object is displayed on the HMD 100. Then, the CPU 200 (output image generation unit 107) generates an output image including the image of the virtual object for test with the set resolution, and transmits the output image to the HMD 100.

In S903, the CPU 300 (composite image generation unit 103) displays an image (video) on the display unit 104. In a case where the output image output from the information processing apparatus 108 can be received and processed, the composite image generation unit 103 displays the composite image based on the output image on the display unit 104. However, depending on the resolution of the output image, the composite image based on the output image may not be displayed on the display unit 104.

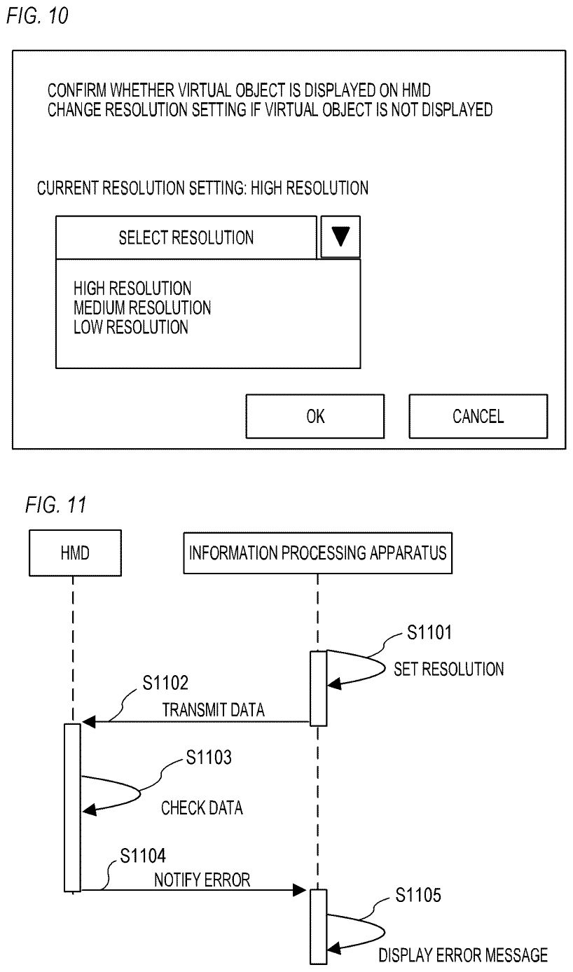

In S904, the CPU 200 performs control to issue a predetermined notification that prompts the user to confirm whether or not the composite image is displayed on the display unit 104 (whether or not the virtual object is displayed on the display unit 104). For example, the CPU 200 performs control to display a predetermined message on a display connected to the information processing apparatus 108. FIG. 10 is a schematic diagram of a confirmation screen displayed on a display connected to the information processing apparatus 108. The user confirms whether or not the composite image is displayed (whether or not the virtual object is displayed) by viewing the confirmation screen of FIG. 10. If the composite image is not displayed, the user changes the resolution of the output image, and repeats display confirmation and setting change until the composite image is displayed on the HMD 100. The setting screen in FIG. 10 includes a message “Change resolution setting”, but may include a message indicating a direction in which the resolution is changed, such as “Reduce resolution”.

As described above, in the third embodiment, the user is notified of a change in the resolution of the output image as a countermeasure for the case where the HMD 100 cannot display the video (composite image) based on the output image. As a result, the user can change the resolution of the output image so that the virtual object is displayed on the HMD 100 (display unit 104).

### Fourth Embodiment

In the third embodiment, the user performs setting of the resolution of the output image in the information processing apparatus 108, confirms whether or not the virtual object is displayed with the user's eyes, and changes the resolution if the virtual object is not displayed. In the fourth embodiment, when the HMD 100 receives the output image, data check of the output image is performed, and the check result is notified to the information processing apparatus 108. In the case where the HMD 100 cannot display the virtual object, the information processing apparatus 108 notifies the user of the fact.

FIG. 11 is a sequence chart of the HMD 100 and the information processing apparatus 108 according to the fourth embodiment.

In S1101, similarly to S901 in FIG. 9, the CPU 200 (output image generation unit 107) performs setting of the resolution of the output image according to the user's operation.

In S1102, similarly to S902, the CPU 200 (rendering unit 106) renders a virtual object for test. Then, the CPU 200 (output image generation unit 107) generates an output image including the image of the virtual object for test with the set resolution, and transmits the output image to the HMD 100.

In S1103, the CPU 300 performs a data check of the output image received from the information processing apparatus 108. As a result of the data check in S1103, in the case where the HMD 100 cannot display the virtual object, the CPU 300 transmits a predetermined signal (error signal) to the information processing apparatus 108 in S1104. When the information processing apparatus 108 receives the error signal, the CPU 200 performs control to give a predetermined notification (error notification) to the user in S1105.

The case where the HMD 100 cannot display the virtual object is, for example, the case where the output image (data of the output image) received by the HMD 100 is damaged or the case where the data format of the output image is not the data format assumed by the HMD 100. In the case where the output image (data of the output image) received by the HMD 100 is damaged, an error signal indicating the data damage is transmitted from the HMD 100 to the information processing apparatus 108, and the user is notified of the data damage. When the user grasps the data damage, the user attempts reconnection between the HMD 100 and the information processing apparatus 108, retransmission of the output image, or the like.

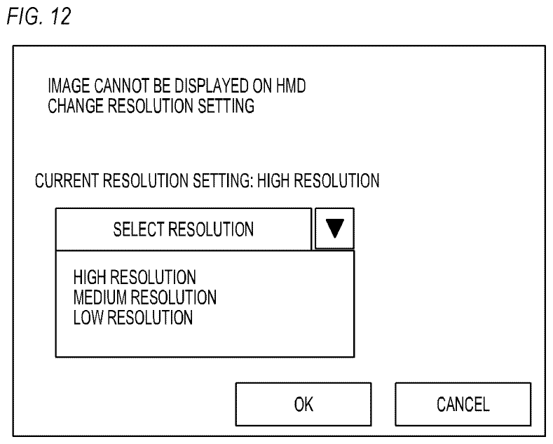

In the case where the data format of the output image is not the data format assumed by the HMD 100, an error signal indicating mismatching of the data format is transmitted from the HMD 100 to the information processing apparatus 108, and a notification prompting a change in the data format (for example, resolution) is given to the user. For example, the error screen of FIG. 12 is displayed on a display or the like connected to the information processing apparatus 108. Note that the CPU 200 may automatically perform image size reduction processing to reduce the resolution (image size) in response to the reception of the error signal without displaying the error screen of FIG. 12.

As described above, in the fourth embodiment, when the HMD 100 cannot display the video (composite image) based on the output image, a predetermined notification is given to the user. As a result, the user can change the resolution of the output image without confirming the HMD 100.

Although the preferred embodiments of the present disclosure have been described above, the present disclosure is not limited to these embodiments, and various modifications and changes can be made within the scope of the gist of the present disclosure.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, data of a virtual object can be transmitted and received by a general communication method.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-028587, filed Feb. 26, 2025, which is hereby incorporated by reference herein in its entirety.

What is claimed is:

1. An electronic device comprising
one or more processors and/or circuitry configured to execute:
first acquisition processing of acquiring information of a position and an orientation of a display device;
generation processing of generating one piece of image data including data of a virtual object image representing a virtual object, data of transparency of the virtual object image, and data of a depth of the virtual object, on a basis of the information acquired by the first acquisition processing; and
transmission processing of transmitting the one piece of image data generated by the generation processing to outside.

2. The electronic device according to claim 1, wherein
in the generation processing,
rendering of the virtual object is performed on a basis of the information acquired by the first acquisition processing, and
the one piece of image data is generated on a basis of a result of the rendering.

3. The electronic device according to claim 2, wherein
the result of the rendering includes first data representing the virtual object image and the transparency, and second data that is the data of the depth, and
in the generation processing, the first data is divided into data of the virtual object image and data of the transparency.

4. The electronic device according to claim 1, wherein
in the generation processing, the one piece of image data representing an image in which the virtual object image and an image representing the transparency and the depth are arranged is generated.

5. The electronic device according to claim 1, wherein
in the generation processing, the one piece of image data representing an image in which the virtual object image, an image representing the transparency, and an image representing the depth are arranged is generated.

6. The electronic device according to claim 1, wherein
the one or more processors and/or circuitry further executes image size reduction processing of reducing an image size of the one piece of image data generated by the generation processing to an image size of a threshold in a case where the image size of the one piece of image data is larger than the threshold, and
in a case where the image size of the one piece of image data generated by the generation processing is larger than the threshold, in the transmission processing, image data reduced by the image size reduction processing is transmitted to the outside.

7. The electronic device according to claim 6, wherein
the threshold is an image size defined by DisplayPort standard.

8. The electronic device according to claim 6, wherein
the threshold is an image size of 3840×2160 or less.

9. The electronic device according to claim 6, wherein
the one or more processors and/or circuitry further executes setting processing of setting an image size designated by a user as an image size of image data to be generated by the generation processing.

10. The electronic device according to claim 6, wherein
the one piece of image data transmitted by the transmission processing is input to the display device, and
the one or more processors and/or circuitry further executes first reception processing of receiving a predetermined signal in a case where the display device is unable to display a video based on the one piece of image data.

11. The electronic device according to claim 10, wherein
the one or more processors and/or circuitry further executes:
control processing of performing control to give a predetermined notification to a user in a case where the predetermined signal is received by the first reception processing; and
setting processing of setting an image size designated by a user as an image size of image data to be generated by the generation processing.

12. The electronic device according to claim 10, wherein
the one or more processors and/or circuitry further executes image size reduction processing of reducing an image size of image data to be generated by the generation processing in a case where the predetermined signal is received by the first reception processing.

13. The electronic device according to claim 1, wherein
in the transmission processing, the one piece of image data is transmitted in accordance with DisplayPort standard.

14. A display device comprising
one or more processors and/or circuitry configured to execute:
second reception processing of receiving the one piece of image data transmitted from the electronic device according to claim 1;
second acquisition processing of acquiring data of a real space image representing a real space and data of a depth of the real space;
composition processing of generating composite image data in which the virtual object is superimposed on the real space, on a basis of the one piece of image data received by the second reception processing and the data of the real space image and the data of the depth acquired by the second acquisition processing; and
display processing of displaying a video based on the composite image data.

15. A control method of an electronic device, comprising
acquiring information of a position and an orientation of a display device;
generating one piece of image data including data of a virtual object image representing a virtual object, data of transparency of the virtual object image, and data of a depth of the virtual object, on a basis of the information; and
transmitting the one piece of image data to outside.

16. A non-transitory computer readable medium that stores a program, wherein the program causes a computer to execute a control method of an electronic device, the control method comprising
acquiring information of a position and an orientation of a display device;
generating one piece of image data including data of a virtual object image representing a virtual object, data of transparency of the virtual object image, and data of a depth of the virtual object, on a basis of the information; and
transmitting the one piece of image data to outside.
